(19) United States
(12) Patent Application Publication
(10) Pub. No.: US 2017/0134251 A1
(43) Pub. Date: May 11, 2017

(54) METHOD AND DEVICE FOR RAPIDLY DETECTING SENSITIVITY OF A WIRELESS RADIO-FREQUENCY RECEIVER

(71) Applicant: South University of Science and Technology of China, Shenzhen (CN)

(72) Inventors: Zhi QUAN, Shenzhen (CN); Jie ZHANG, Shenzhen (CN)

(21) Appl. No.: 15/411,287

(22) Filed: Jan. 20, 2017

Related U.S. Application Data
(63) Continuation of application No. PCT/CN2015/093565, filed on Nov. 2, 2015.

(30) Foreign Application Priority Data
Oct. 28, 2015 (CN) 201510713741.9

(51) Int. Cl. H04L 12/26; H04B 17/29

(52) U.S. Cl. CPC H04L 43/0823; H04B 17/29

(57) ABSTRACT

A method is provided for rapidly detecting sensitivity of a wireless radio-frequency receiver and a device thereof. With improved algorithms, received signal powers under a target packet error rate are rapidly detected and thus the sensitivity of the receiver is obtained, and further with a probability computation method, the quantity of data packets to be inspected during each packet error rate measurement under a certain confidence level condition is obtained, so that the time of a single measurement is greatly shortened. The method and device of the invention has the advantages that the computation is greatly simplified compared with the existing receiver sensitivity measurement methods so that the detection efficiency of detectors is improved, and the detection method is optimized so that the precision is ensured, the working efficiency in the industrial detection field is improved, and the production costs are reduced.

### CROSS-REFERENCE TO RELATED APPLICATIONS

This application is a continuation of International Application PCT/CN2015/093565, filed on Nov. 2, 2015, which claims priority to Chinese Application No. 201510703741.9, filed Oct. 28, 2015, the contents of each of which are hereby incorporated by reference.

### FIELD OF THE INVENTION

The present invention relates to a method and device for rapid sensitivity detection, and in particular to a method and device for rapid detection of sensitivity of a wireless radio-frequency receiver. The present invention belongs to the fields of wireless radio-frequency communication, electronic measurement, automatic control and detection, or other associated fields.

### BACKGROUND

The receiver is a basic component of a mobile phone, a notebook computer and various wireless apparatuses. The wireless apparatuses must be subjected to various performance detections, including the detection of sensitivity of the receiver, during research-development and production. The sensitivity of the receiver is generally determined by detecting the packet error rate. The packet error rate is a ratio of the quantity of error data packets to the total quantity of transmitted data packets after signals are received by the receiver, and it is generally expressed as a percentage. The determination of the sensitivity of the receiver is very necessary and important, especially in modern digital communication systems. Due to the influence of difference among analog devices, there are great differences among the sensitivity of wireless receivers of the same type. During the sensitivity detection of the receiver, in order to measure and obtain the sensitivity of the single wireless receiver, detectors usually need to start the packet error rate detection from a certain received power and continuously vary received power values of the receiver, till the detection result meets a target packet error rate, thereby obtaining the actual sensitivity. Meanwhile, during each detection of sensitivity of the receiver, the detectors need to detect a large quantity of data packets in order to obtain reliable packet error rate estimated values. At this point, the whole detection process is tedious, is full of repeatability and includes a large quantity of unnecessary detection. Such detection method of continuously varying the received power of a receiving end involves a large amount of work, and the working efficiency of the detectors is reduced. During industrial production, there is a need to reduce the number of detections in order to shorten the detection time of each receiver and improve the detection efficiency of the detectors.

### SUMMARY

In order to overcome the above-mentioned problem of low detection efficiency caused by a large number of unnecessary detections, the present disclosure provides a method and device for implementing rapid detection of sensitivity of a wireless radio-frequency receiver.

In one aspect, the technical solution of the present disclosure provides a method for rapidly detecting sensitivity of a wireless radio-frequency receiver. The method comprises the following steps: setting a detection range, and ensuring that a packet error rate estimation range corresponding to received power in the detection range includes a target packet error rate; based on the detection range, determining the quantity of data packets needing to be detected for packet error rate detection under a confidence level condition; narrowing down/searching the detection range, deciding a variable adjustment quantity of the received power according to packet error rate estimated value detection results, and further deciding the received power during next narrowing down/searching of the detection range; and if the absolute value of a difference value between the detected packet error rate estimated value and the target packet error rate is smaller than a precision threshold, utilizing the received power corresponding to the estimated packet error rate as the sensitivity of the wireless radio-frequency receiver.

As an improvement on the method for rapid detection of sensitivity of the wireless radio-frequency receiver, the step of setting a detection range comprises: on the basis that the packet error rate of the wireless radio-frequency receiver exhibits a trend of monotone variation along with the increasing of the received power of the receiver, obtaining an upper limit value and a lower limit value of the packet error rate respectively corresponding to an upper limit value and a lower limit value of the received power in the detection range; and determining that the target packet error rate is between the obtained upper limit value and the lower limit value of the packet error rate.

As a further improvement on the method for rapid detection of sensitivity of the wireless radio-frequency receiver, the step of narrowing down/searching the detection range comprises: iteratively selecting or adjusting the received power in the detection range till the absolute value of the difference between the detected packet error rate estimated value corresponding to the selected or adjusted received power and the target packet error rate is smaller than an approximated threshold.

Preferably, the step of narrowing down/searching the detection range comprises: in an iteration process, randomly selecting the received power and adjusting the speed at which the randomly selected received power converges toward the target received power according to the currently detected packet error rate estimated value and the difference value between the currently detected packet error rate estimated value and the target packet error rate.

Preferably, the step of narrowing down/searching the detection range comprises: in the iteration process, utilizing a dichotomy and/or exponential adjustment quantity function, and calculating a next selected or adjusted received power according to the previously selected received power.

Preferably, the step of narrowing down/searching the detection range comprises: in the detection range, fitting at least two received power values and corresponding detected packet error rates to obtain a packet error rate-received power curve function, calculating a received power estimated value by utilizing the fitted packet error rate-received power curve function and the target packet error rate, detecting a packet error rate estimated value by utilizing the calculated received power estimated value, combining it with the new detected packet error rate estimated value to update the packet error rate-received power curve function and re-calculate a received power estimated value, and carrying out iteration sequentially till the absolute value of a difference value between the detected packet error rate estimated value and the target packet error rate is smaller than the approximated threshold.

As a further improvement on the method for rapid detection of sensitivity of the wireless radio-frequency receiver, the step of determining the quantity of data packets needing to be detected for packet error rate detection under a confidence level condition comprises: detecting multiple received power values in the detection range, and detecting packet error rates at the multiple received powers, thereby fitting a packet error rate-received power curve; in the case of approximating the target packet error rate step by step by utilizing the dichotomy, obtaining a mathematic correspondence relation between the quantity of data packets needing to be detected and a probability corresponding to the target packet error rate and detected as correct by utilizing the fitted packet error rate-received power curve; and finally obtaining the quantity of the data packets needing to be detected that is required by the probability corresponding to the target packet error rate, achieving a preset value and detected as correct.

As a further improvement on method for rapid detection of sensitivity of the wireless radio-frequency receiver, the step of determining the quantity of data packets needing to be detected for packet error rate detection under a confidence level condition comprises: detecting multiple received powers in the detection range, and detecting packet error rates at the multiple received powers, thereby fitting a packet error rate-received power curve; performing calculation by utilizing the fitted packet error rate-received power curve, thereby obtaining a packet error rate estimated value at any one received power; and calculating the optimal sending quantity of packets at the current received power according to the estimated packet error rate at the current received power and the preset target confidence level.

As a further improvement on the method for rapid detection of sensitivity of the wireless radio-frequency receiver, in a detection range narrowing down/searching process, the quantity of data packets needing to be detected that are utilized in the detection range is constant; or the quantity of the data packets needing to be detected is adjusted in real time according to the selected or adjusted received power values.

In another aspect, the present disclosure provides a device for rapidly detecting sensitivity of a wireless radio-frequency receiver. The device comprises a processor and a computer readable storage medium, wherein the computer readable storage medium stores instructions and is used for helping the processor to perform the following steps: setting a detection range, and ensuring that a packet error rate estimation range corresponding to received power in the detection range includes a target packet error rate; based on the detection range, determining the quantity of data packets needing to be detected for packet error rate detection under a confidence level condition; narrowing down/searching the detection range, deciding a variable adjustment quantity of the received power according to packet error rate estimated value detection results, and further deciding the received power during next narrowing down/searching of the detection range; and if the absolute value of a difference value between the detected packet error rate estimated value and the target packet error rate is smaller than a precision threshold, utilizing the received power corresponding to the estimated packet error rate as the sensitivity of the wireless radio-frequency receiver.

Furthermore, the instructions stored in the device for rapid detection of sensitivity of the wireless radio-frequency receiver further can help the processor to perform any steps of the above detection method.

The method and device for rapid detection of sensitivity of the wireless radio-frequency receiver has the beneficial effects that by utilizing the preferable iterative approximation algorithms, received signal power at the target packet error rate is rapidly detected, and then the sensitivity of the receiver is obtained, and the detection range is narrowed down; according to the probability calculation method, the quantity of data packets needing to be detected during each packet error rate measurement under a certain confidence level condition is obtained, so that the sending quantity of packets is greatly reduced and a large amount of measurement time is saved; and on the premise of ensuring the detection precision, the detection efficiency of detectors is improved, the working efficiency of the industrial detection field is improved, and the production costs is reduced.

### BRIEF DESCRIPTION OF THE DRAWINGS

A person of ordinary skill in the art will understand that the following accompanying drawings are merely meant to be illustrative, but not to limit the scope of the present invention in any manner, wherein:

FIG. 1 is a schematic diagram of received power searching according to an embodiment of the present invention;

FIG. 2 is a schematic diagram of packet error rate measured values, packet error rate truth values, received powers and a target point according to an embodiment of the present invention;

FIG. 3 is a flow chart of calculating the received power by iteratively approximating a target packet error rate according to an embodiment of the present invention;

FIG. 4 is a flow chart of calculating the received power by performing received power adjustment based on monotonicity between the packet error rate and the received power according to another embodiment of the prevent invention;

FIG. 5 is a flow chart of calculating the quantity of packets to be sent for detection according to an embodiment of the present invention;

FIG. 6 is a flow chart of calculating the quantity of the packets to be sent for detection according to another embodiment of the present invention;

FIG. 7 is a curve chart of the quantity of the packets to be sent for detection and a probability detected as correct according to an embodiment of the present invention; and

FIG. 8 is a schematic diagram of a system model for rapid detection of sensitivity of a wireless radio-frequency receiver according to an embodiment of the present invention.

### DETAILED DESCRIPTION OF THE PREFERRED EMBODIMENTS

A method for rapid sensitivity detection for a wireless radio-frequency receiver comprises the following steps: setting a detection range, to allow a packet error rate estimation range corresponding to received power in the detection range to comprise a target packet error rate; narrowing down the detection range through a searching mechanism and selecting the quantity of packets to be sent during packet error rate detection through a packet-sending quantity setting mechanism; and by utilizing an estimated packet error rate approximating the target packet error rate under a certain condition, detecting the received power as the sensitivity of the wireless radio-frequency receiver. The following describes setting the detection range, the searching mechanism and the packet-sending quantity setting mechanism in details through multiple embodiments.

1. Setting of a Detection Range

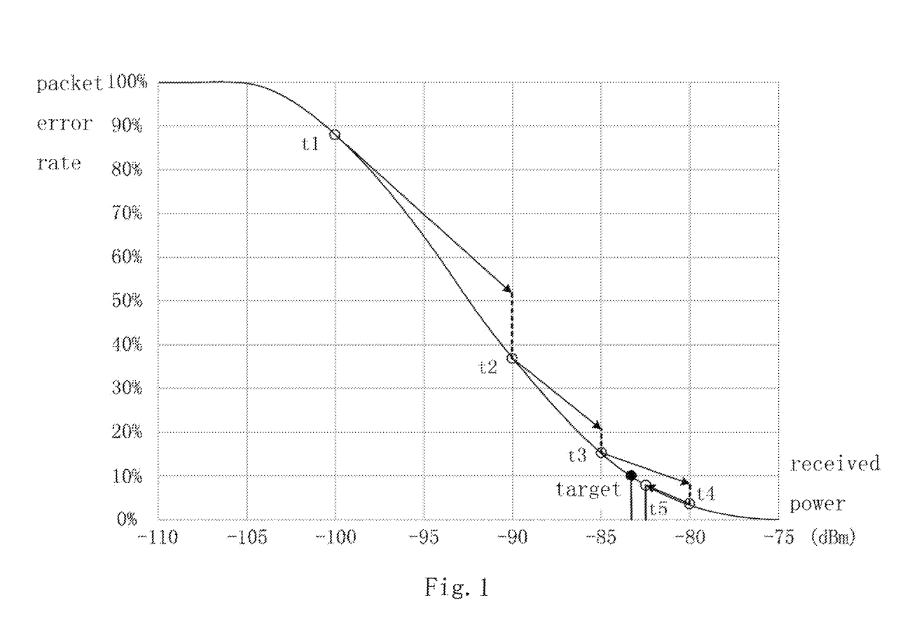

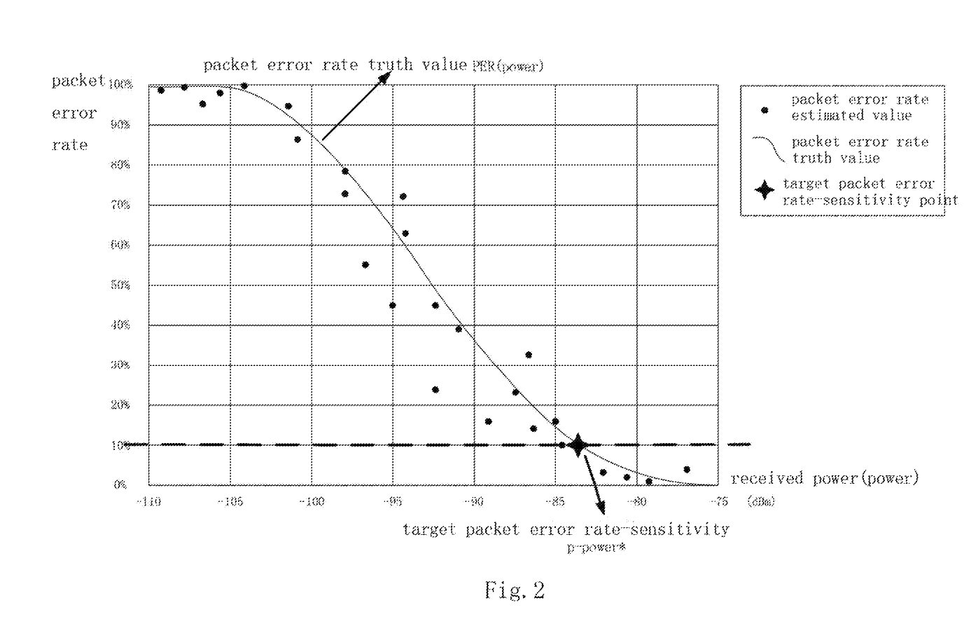

In most wireless communication apparatus modules, a functional relation curve of packet error rate of a receiving end apparatus and the received power of a receiver exhibits a monotone decreasing trend. For receivers of apparatuses of different types, specific functional relation curves of the packet error rate and the received powers may be different from each other, but have the same monotone trend. Exemplary packet error rate-received power curves are shown in the FIGS. 1 and 2. In an embodiment, on the basis that the packet error rate of the wireless radio-frequency receiver exhibits the monotone variation trend along with the increasing of the received power of the receiver, an upper limit value and a lower limit value of the packet error rate respectively corresponding to an upper limit value and a lower limit value of the received power in the detection range are obtained, thereby to set the detection range.

2. Searching Mechanism

A main implementation manner of the searching mechanism provided by the present invention can be described as: an adjustment quantity is obtained through computation with an initial estimation result and thus a next estimated sensitivity (or received power) is obtained. During each search, the received power of the receiver is adjusted, and the adjustment quantity is variable, that is, each adjustment quantity of the received power is determined by the already-existing detection data result, and a received power value utilized in the next search is determined by such new adjustment quantity of the received power and the value of the received power at that time. FIG. 1 is a schematic diagram showing the searching of the variable adjustment quantity.

According to difference of the reference information, the adjustment quantity can be calculated by the following methods:

Method 1: Stochastic Approximation Method

When the packet error rate of the receiver is being measured, a measured value can be taken as a mean which is a random variable of the packet error rate of a given received power, that is, the measured value of the packet error rate and the received power are two associated random variables, wherein a target packet error rate-sensitivity point is a target point needed. FIG. 2 is a schematic diagram showing the packet error rate measured values, packet error rate truth values, the received power and the target point, wherein the received power is power, the target packet error rate is p (p=10% in FIG. 2), an expression of the packet error rate truth value is PER (power), the packet error rate measured value, i.e., the packet error rate estimated value is [symbol] (power), and to-be-calculated sensitivity of the receiver is assumed to be power* (namely the received power at p=10%).

Assuming the received power during K-th detection is power_{K} and the received power during the (K−1)-th detection is power_{K-1}, the sensitivity power* of the receiver can be obtained by estimating and sequentially approximating based on the following equation:

power_{K}=power_{K-1}+α_{K-1} [symbol] (power_{K-1}).

Wherein, α_{K-1} is a coefficient meeting strict-control convergence speed limiting conditions.

By increasing the number of detection, the received powers can be continuously revised, such that the packet error rate estimated value approximates to the target packet error rate p step by step till | [symbol] (power_{M})−p|<ε1, and at this point, the received power is the sensitivity of the receiver. ε1 is precision degree and is determined by product requirements. Furthermore, even if random fluctuation causes an error revision direction in an iteration calculation process, such error revision direction does not infinitely continue finally and is certainly revised to a correct direction in due time. Moreover, the larger the error is, the larger the possibility of being revised is. Therefore, rapid convergence is achieved, and the number of detections is reduced.

Method 2: Curve-Fitting-Based Iterative Approximation Method

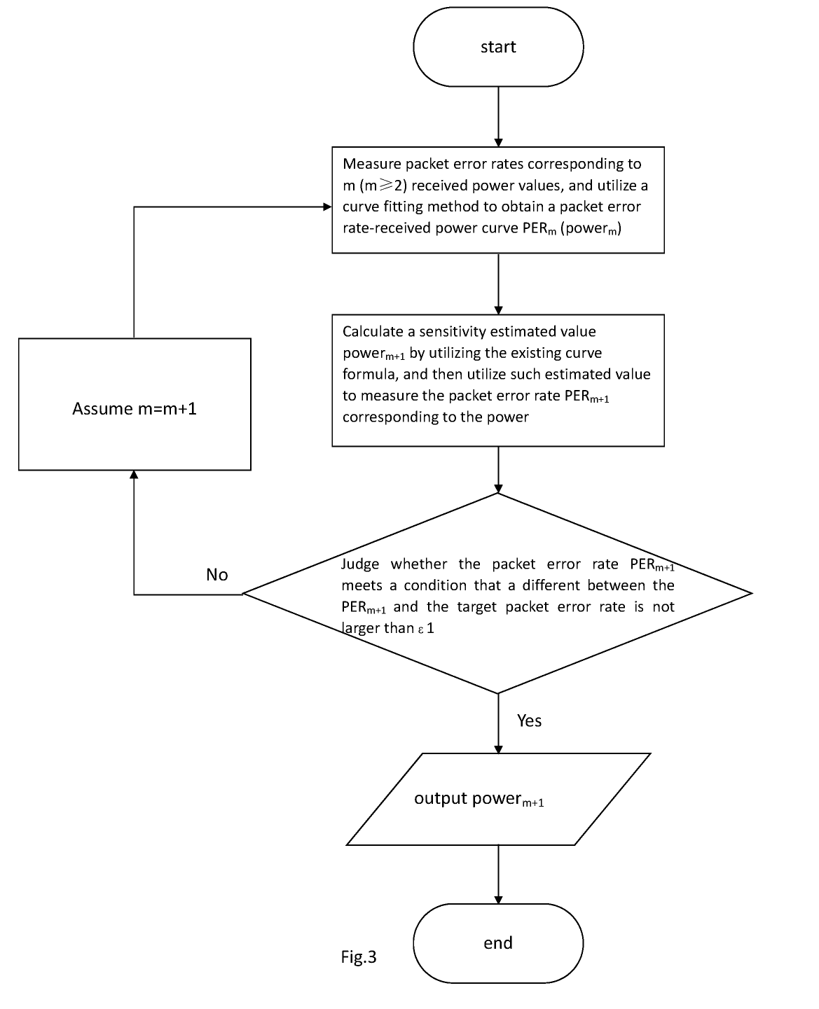

The function [symbol] (power) is obtained by measuring and fitting packet error rates over m(m>=2) received powers, and is used for inferring a target point, thereby obtaining an initial estimated value of the sensitivity. The initial estimated value of the sensitivity is used for detecting the packet error rate, thereby obtaining new detection data. By combining with the new detection data, a curve fitting function is updated, and the target point is inferred again; and finally the sensitivity of the receiver is obtained by sequential iteration. Referring to the flow chart of the FIG. 3, the method comprises the following specific calculation steps:

step 1: measuring packet error rates over m(m>=2) received powers, wherein sufficient data packets are utilized during each measurement in order to obtain the precise packet error rate; and utilizing a curve fitting method to obtain a packet error rate-received power curve [symbol] (powerₘ);

step 2: calculating the following equation:

powerₘ₊₁=powerₘ− [symbol] (powerₘ)/ [symbol] (powerₘ)

wherein [symbol] (powerₘ); represents a first derivative function of the function [symbol] (powerₘ); thereby obtaining a first estimated value powerₘ₊₁ of the sensitivity of the receiver; and adjusting a received power value of the receiver, and assuming the received power value to be powerₘ₊₁, thereby measuring and obtaining a corresponding packet error rate estimated value P [symbol] ₊₁(powerₘ₊₁); and

step 3: judging whether the packet error rate of the sensitivity estimated value meets P [symbol] ₊₁(powerₘ₊₁)−p|<ε1; if no, assuming m=m+1, and returning to step 1; and if yes, determining that the powerₘ₊₁ is the sensitivity of the receiver.

Method 3: Presetting of an Adjustment Quantity Function

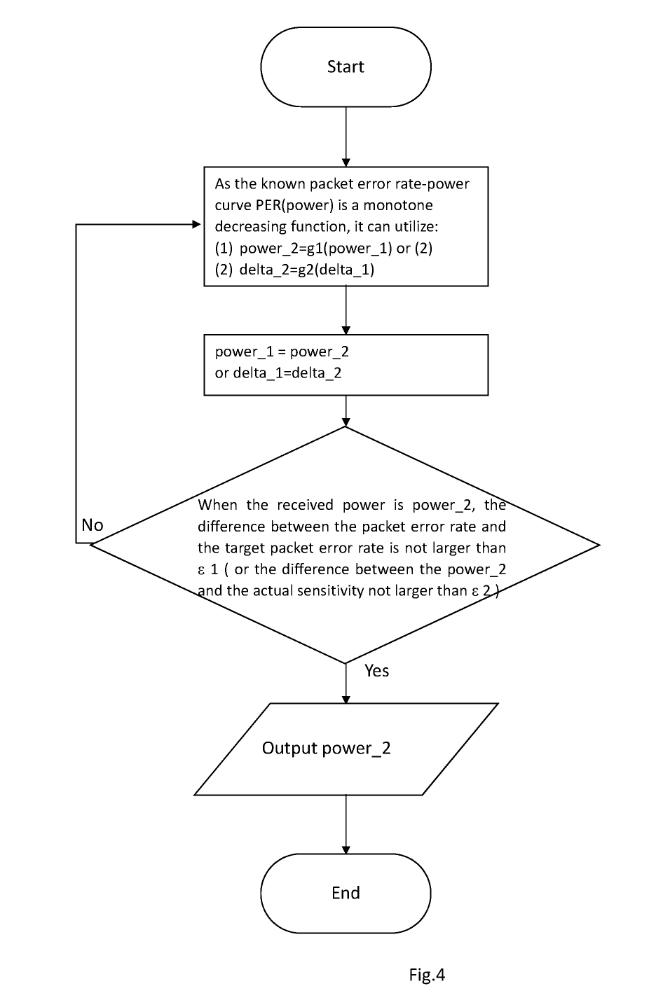

The packet error rate of the receiving end apparatus always exhibits a general trend of monotone decreasing along with the increasing of the received power of the receiver. Based on such monotonicity alone, when the characteristics of a packet error rate-received power curve of the receiver do not need to be additionally considered, and after each search is completed, a new adjustment quantity of the received power or a received power value utilized in the next search can be obtained by calculating a certain expression, and variables in the expression are associated with received power values or adjustment quantities of the received power during previous one or more searches. Such expression can be obtained according to the dichotomy principle, that is, a received power value utilized in the next search is a mid-value of previous twice useful power values; and the expression can also be a certain exponential function, that is, the new adjustment quantity of the received power and the adjustment times have an exponential relation and the like. FIG. 4 is a flow chart of received power adjustment based the monotonicity only.

In the flow chart of FIG. 4, power_1 and power_2 are both received power values and delta_1 and delta_2 are both power adjustment quantities. Further, g1 and g2 are both function expressions, and each expression shows only one variable, but in actual use, each expression can be decided by various variables. For example, if the algorithm utilizes the dichotomy, power_mid=g1(power_up, power_low). Further, power_2 can be obtained through the function g1, and can also be determined by an initial received power and a power adjustment quantity together. After a series of judgments and iterations are performed, power_2 is the measured sensitivity of the receiver.

The dichotomy comprises the following calculation steps:
(1), taking two received power values powerᵤₚ and power_{low}, and making sure [symbol] (power_{low})>p, [symbol] (powerᵤₚ)<p;
(2), letting power_{mid}=(powerᵤₚ+power_{low})/2; if [symbol] (power_{mid})>p; letting power_{low}=power_{mid}; otherwise, letting powerᵤₚ=power_{mid}; and
(3), repeating step (2) till [symbol] (power_{mid})−p|<ε1 or |powerᵤₚ−power_{low}|<ε2, wherein ε1 and ε2 are the precision degrees, which are generally determined by requirements of manufacturers.

The exponential function comprises the following calculating steps:
(1), assuming an adjustment quantity function to be deltaₖ=αa^{-βk}, wherein α, β and a are parameters, and K represents the number of detections;
(2), assuming the received power to be powerₖ=powerₖ₋₁+deltaₖ₋₁;
(3), repeating step (2) till | [symbol] (power_{K})−p|<ε1.

3. Packet-Sending Quantity Setting Mechanism

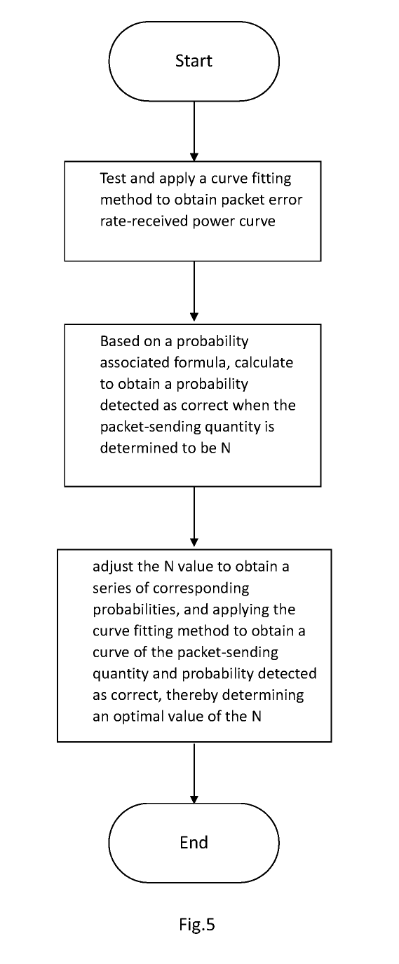

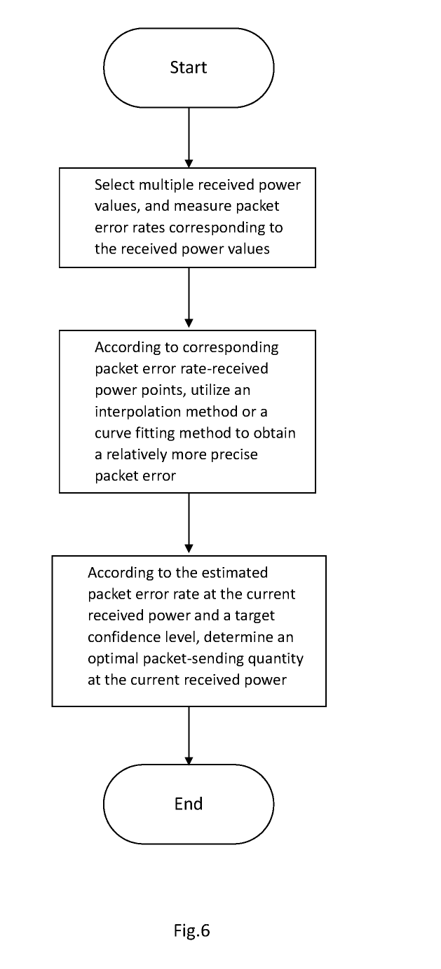

The setting of the packet-sending quantity can be decided by two different mechanisms, and results of the two different mechanisms ensure that the packet error rate meets a certain probability requirement (such as the confidence level of 95%). The first mechanism is that: according to a packet error rate-received power curve, the packet-sending quantity suitable for a certain power range and meeting a certain probability requirement is obtained, and this packet-sending quantity is a constant value. FIG. 5 is a flow chart of a calculation method of the first mechanism. The second mechanism is: according to the packet error rate probability distribution condition, a mathematic model is established; and combining with the provided algorithms, the packet-sending quantity meeting a certain packet error rate confidence level will be obtained. This packet-sending quantity is adjusted according to the different received power values, and the adjustment result is obtained through data calculation. FIG. 6 is a flow chart of a calculation method of the second mechanism.

In some embodiments, the quantity of data packets to be detected that are utilized in the detection range is constant, or the quantity of the data packets needing to be detected is adjusted in real time according to the selected or adjusted received power values. Therefore, the packet-sending quantity can be set to be constant or variable, and a calculation method of the sent packet quantity in specific embodiments is as follows.

Calculation Method of the Constant Sent Packet Quantity

firstly various power values are detected, thereby obtaining corresponding packet error rates; a packet error rate curve of the receiving end apparatus is estimated by utilizing a curve fitting method; and in the case of approximating a target packet error rate step by step by utilizing the dichotomy, a mathematic correspondence relation between the quantity of the packets needing to be detected and a probability corresponding to the target packet error rate and detected as correct is obtained by utilizing the curve information;

a calculation expression of the probability detected as correct can be obtained according to the characteristics of the dichotomy; the packet-sending quantity during each detection is assumed to be Nᵢ, a probability value of [symbol] >p is pᵢ, the detection correction probability is Pc, and the other parameters are the same as the above mentioned;

when the dichotomy is utilized, a power upper limit value is assumed to be powerᵤₚ and a power lower limit value is assumed to be power_{low}, thereby obtaining the maximum number of detections to be

$$L = ⌈ {log}_{2} \frac{{power}_{up} - {power}_{low}}{ɛ 2} ⌉ ,$$

wherein ε2 represent the precision degree and is the same as ε2 in the calculation steps of the dichotomy in the Method 3: presetting of an adjustment quantity function;

$${P}_{i} = \{ \begin{matrix}{\sum }_{k = 0}^{p * N - 1} ( \begin{matrix}N \\ k\end{matrix} ) {k}^{} ( {power}_{i} ) {( 1 - ( {power}_{i} ) )}^{N - k} , & \begin{matrix}if {power}_{i} > \\ sensitivity estimated value\end{matrix} \\ {\sum }_{p * N + 1}^{N} ( \begin{matrix}N \\ k\end{matrix} ) {k}^{} ( {power}_{i} ) {( 1 - ( {power}_{i} ) )}^{N - k} , & \begin{matrix}if {power}_{i} < \\ sensitivity estimated value\end{matrix} \\ ( \begin{matrix}N \\ p * N\end{matrix} ) {k}^{} ( {power}_{i} ) {( 1 - ( {power}_{i} ) )}^{N - k} , & \begin{matrix}if {power}_{i} = \\ sensitivity estimated value\end{matrix}\end{matrix} \\ Pc = {\prod }_{i = L}^{L} {p}_{i} \qquad$$

The calculation steps are as follows:

Step 1: firstly setting N=100, and utilizing the above equation set, thereby obtaining Pc (N=100);

Step 2: secondly setting N=200, and utilizing the above equation set, thereby obtaining Pc (N=200);

Step 3: performing analogy on the step 1 and the step 2, and continuously increasing the value of N till N=10000;

Step 4: utilizing a curve fitting or interpolation method to obtain a Pc-N curve (whose horizontal coordinate is N, and longitudinal coordinate is Pc); and

Step 5: according to the production requirements, determining Pc (for example, when Pc>75%, the corresponding N value is acceptable), and according to the Pc-N curve, obtaining the minimum N value meeting the requirements.

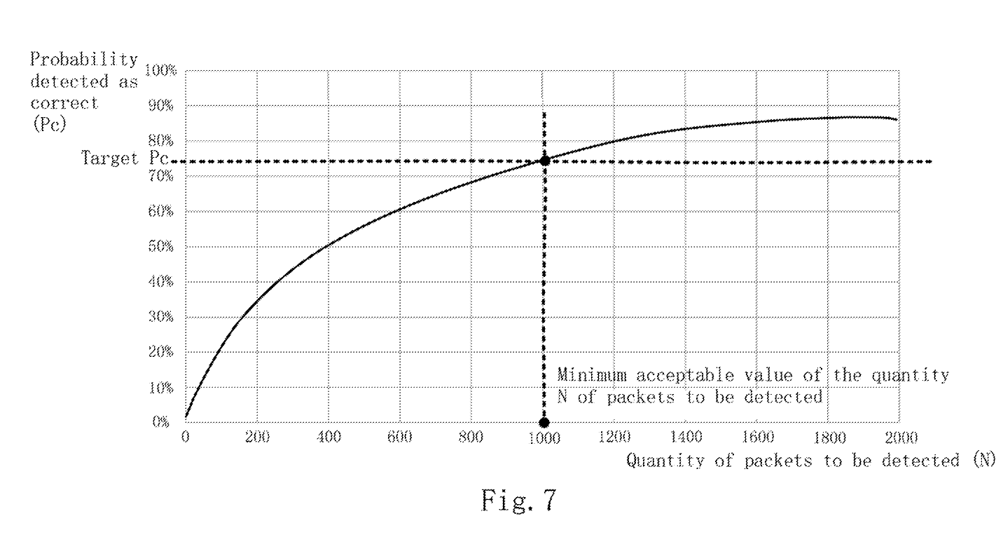

The FIG. 7 is a schematic diagram of utilizing the Pc-N curve to obtain the minimum quantity of packets needing to be detected. Along with the increasing of the data packet quantity, the probability (Pc) of the packet error rate detected as correct also increases, so that the minimum value of the packet-sending quantity needed when a certain correct probability is achieved can be obtained, and this minimum value is a detection setting value.

Calculation Method of the Variable Packet-Sending Quantity

In most cases, the packet error rate meets binomial distribution, and it can be known that its statistical property can be approximated to normal distribution based on the central limit theory. According to the algorithms, mathematical correspondence relations between the packet-sending quantity, the confidence level and the packet error rate can be obtained (by utilizing different types of binomial intervals, the specific correspondence relation expressions will be different, but have no great differences); in order to obtain the packet-sending quantity utilized during each search, firstly multiple received power values need to be selected to obtain corresponding packet error rates (at this point, the quantity of the packets needing to be detected should be relatively large in order to obtain a relatively more precise packet error rate estimated value); and then according to the data points, by utilizing the curve fitting or interpolation method and the like, a packet error rate-received power curve chart is obtained, that is, a corresponding packet error rate estimated value at any one received power is obtained; and according to the estimated packet error rate at the current received power and the preset target confidence level, the optimal sending quantity of packets at the current received power can be determined. Specific calculation method is as follows.

Assuming a bilateral confidence interval is utilized, such as the Agresti-Coull (AC) confidence interval, its interval length is 2Δ, and the packet-sending quantity is:

$${\hat{N}}_{AC} = \frac{{z}_{α / 2}^{2} ( power ) [ 1 - ( power ) ]}{{Δ}^{2}} - {z}_{α / 2}^{2} .$$

If the confidence level is selected as 95%, α=0.05, and Z+/ZZ=3.84˜4, wherein the calculation of the parameter Δ has two selections, (1) Δ=p* [symbol] , ρε(0,1) or (2) Δ=ω₀/2 is a constant.

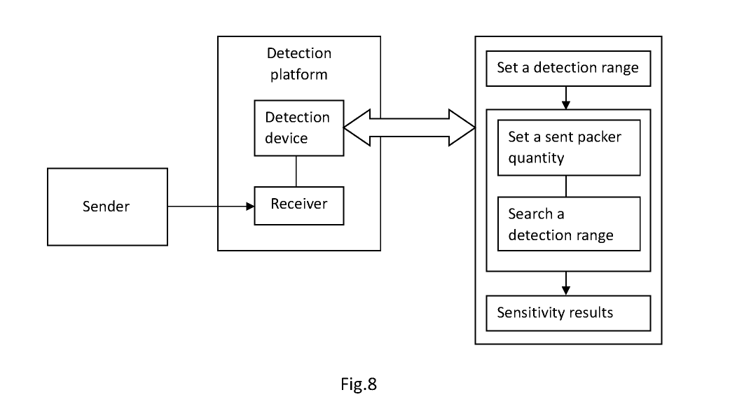

FIG. 8 is a schematic diagram of a system model for rapid detection of sensitivity of a wireless radio-frequency receiver according to an embodiment of the present invention. A sender sends data to be detected to a receiver through a transmission medium. In the detection process, a detection device in a detection platform may adjust the received power of the receiver, detect the sending quantity of packets of a packet error rate, and output a calculated sensitivity detection result.

According to some implementation requirements, the embodiments of the present invention may be implemented in hardware or software. Digital storage mediums on which electrically readable control signals are stored may be utilized, and the digital storage mediums cooperate with (or is able to cooperate with) a programmable computer system to perform the corresponding methods. In one embodiment, the detection device provided by the present invention may comprise a processor and a computer readable storage medium, and the computer readable storage medium stores instructions and is used for helping the processor to perform the above-mentioned methods and calculation steps of the present invention.

Merely preferred embodiments of the present invention are described herein, and the present invention is not limited thereto. Embodiments should fall within the protection scope of the present invention as long as they achieve the technical effects of the present invention using the same manner. Various modifications or changes may be made to the technical solution and/or implementation manners of the embodiments within the protection scope of the prevent invention.

What is claimed is:

1. A method for rapidly detecting sensitivity of a wireless radio-frequency receiver comprising:
setting a detection range, in which a packet error rate estimation range corresponding to a received power includes a target packet error rate;
determining the quantity of data packets required for a packet error rate detection under a confidence level condition, based on the detection range;
narrowing down or searching the detection range to determine a variable adjustment value for the received power according to packet error rate estimated value detection results, and further to determine the received power during next narrowing down/searching of the detection range; and
assessing the received power corresponding to the estimated packet error rate as the sensitivity of the wireless radio-frequency receiver, if the absolute value of a difference value between the detected packet error rate estimated value and the target packet error rate is smaller than a precision threshold.

2. The method of claim 1, wherein the setting a detection range further comprises:
on the basis that the packet error rate of the wireless radio-frequency receiver exhibits a trend of monotone variation along with the increasing of the received power of the receiver, obtaining an upper limit value and a lower limit value of the packet error rate respectively corresponding to an upper limit value and a lower limit value of the received power in the detection range; and
ensuring the target packet error rate is between the obtained upper limit value and the lower limit value of the packet error rate.

3. The method of claim 1, wherein the narrowing down or searching the detection range further comprises:
iteratively selecting or adjusting the received power in the detection range till the absolute value of the difference between the detected packet error rate estimated value corresponding to the selected or adjusted received power and the target packet error rate is smaller than an approximated threshold.

4. The method of claim 3, wherein the narrowing down or searching the detection range further comprises:
in an iteration process, randomly selecting the received power, and adjusting the speed at which the randomly selected received power converges toward the target received power according to the difference value between the currently detected packet error rate estimated value and the target packet error rate.

5. The method of claim 3, wherein the narrowing down or searching the detection range comprises:
in the iteration process, utilizing a dichotomy and/or exponential adjustment quantity function, and calculating a next selected or adjusted received power according to the previously selected received power.

6. The method of claim 1, wherein the narrowing down or searching the detection range further comprises:
in the detection range, fitting at least two received power values and respective detected packet error rates to obtain a packet error rate-received power curve function, calculating a received power estimated value by utilizing the fitted packet error rate-received power curve function and the target packet error rate, detecting a packet error rate estimated value by utilizing the calculated received power estimated value, combining it with the new detected packet error rate estimated value to update the packet error rate-received power curve function and re-calculate a received power estimated value, and carrying out the iteration sequentially till the absolute value of a difference value between the detected packet error rate estimated value and the target packet error rate is smaller than the approximated threshold.

7. The method of claim 1, wherein the determining the quantity of data packets to be detected for packet error rate detection under a confidence level condition further comprises:
in the detection range, detecting multiple received powers, and detecting packet error rates at the multiple received powers, thereby fitting a packet error rate-received power curve;
in the case of approximating the target packet error rate step by step by utilizing the dichotomy, obtaining a mathematic correspondence relation between the quantity of the data packets needing to be detected and the detection correction probability corresponding to the target packet error rate by utilizing the fitted packet error rate-received power curve; and
obtaining the quantity of the data packets to be detected and a probability corresponding to the target packet error rate and detected as correct.

8. The method of claim 1, wherein the determining the quantity of data packets to be detected for packet error rate detection under a confidence level condition comprises:
detecting multiple received powers in the detection range, and detecting packet error rates at the multiple received powers, thereby fitting a packet error rate-received power curve;
performing calculation by utilizing the fitted packet error rate-received power curve, thereby obtaining a packet error rate estimated value corresponding to any one received power; and
calculating the optimal sending quantity of packets at the current received power according to the estimated packet error rate at the current received power and the preset target confidence level.

9. The method of claim 1, wherein in a detection range narrowing down/searching process:
the quantity of the data packets to be detected that are utilized in the detection range is constant; or
the quantity of the data packets to be detected is adjusted in real time according to the selected or adjusted received power values.

10. A device for rapidly detecting sensitivity of a wireless radio-frequency receiver, comprising:
a processor, and
a computer readable storage medium configured to store instructions and enable the processor to perform following steps:
setting a detection range, in which a packet error rate estimation range corresponding to a received power includes a target packet error rate;
determining the quantity of data packets required for a packet error rate detection under a confidence level condition, based on the detection range;
narrowing down/searching the detection range to determine a variable adjustment value for the received power according to packet error rate estimated value detection results, and further to determine the received power during next narrowing down/searching of the detection range; and
assessing the received power corresponding to the estimated packet error rate as the sensitivity of the wireless radio-frequency receiver, if the absolute value of a difference value between the detected packet error rate estimated value and the target packet error rate is smaller than a precision threshold.
